(19) United States
(12) Patent Application Publication
(10) Pub. No.: US 2022/0276003 A1
(43) Pub. Date: Sep. 1, 2022

(54) Dental Furnace

(71) Applicant: Ivoclar Vivadent AG, Schaan (LI)

(72) Inventors: Rudolf Jussel, Feldkirch-Gisingen (AT); Manuel Schlegel, Mels (CH); Domink Müller, Altach (AT)

(21) Appl. No.: 17/624,654

(22) PCT Filed: Jul. 3, 2020
(86) PCT No.: PCT/EP2020/068901

§ 371 Date: Jan. 4, 2022

(30) Foreign Application Priority Data
Jul. 4, 2019 (EP) 19184350.7

(51) Int. Cl. F27B 17/02; F27D 99/00; G01K 7/02; G01K 7/25

(52) U.S. Cl. CPC F27B 17/025; F27D 99/0006; G01K 7/02; G01K 7/25; F27D 2019/0003

(57) ABSTRACT

A dental oven for treatment of dental materials having one or more electric heating elements which extends adjacent to a heating space and is controlled by a heating controller. The heating controller regulates the temperature in the heating chamber and includes an output terminal for the heating element and an input terminal for temperature detection, which is electrically connected to a temperature detecting device, wherein the temperature detecting device has the one or more heating elements. The temperature sensing device includes a compensation device for compensation of nonlinearities at temperatures above 700° C. or in nonlinearities of the resistance of the heating element. The heating controller controls its output port based on the detected resistance of the heating element and on the compensation device.

The invention relates to a dental oven, according to the preamble of claim 1, and to a method of operating a dental oven, according to the preamble of claim 12.

Dental ovens include all devices that are used for the heat treatment of dental materials. These can be heat treatment processes such as the firing of dental ceramics, the pressing technique, the preheating of pressed muffles, the sintering of ceramics or also debinding processes as well as hot polymerization units.

On one hand, furnaces are widely used as furnaces on the other hand as press furnaces in order to bring dental restoration parts consisting of a dental ceramic into the desired shape or to heat or fire or sinter them.

The prerequisite for a good heating, firing or sintering result is that of the manufacturer prescribed temperature profile, the so-called firing curve, is strictly adhered to.

For this purpose, high quality thermocouples are typically used in dental ovens, which are calibrated in advance and which detect the temperature profile at the measuring point with an accuracy of a few degrees and even a few tenths of a degree.

Compared to the accuracy of such a thermocouple, the spatial compliance of the temperature drops significantly. Thus, typically within boiler rooms, the temperature gradients are several tens of degrees C. or even over 100 degrees C. in size.

During rapid heating, even temperature gradients of more than 200° C. can occur.

This is especially true for press ovens because the muffle used in the press oven has in comparison with the air-filled boiler room a significantly higher heat capacity, so that it heats up more slowly. The temperature measured by the thermocouple on the surface of the muffle may then be for example 800°, while the blank in the muffle, for example, only 400° C. warm.

Such measurement errors are taken into account by quite complicated specifications for the firing curves of the manufacturer, which then also depend on the muffle size, so that heating, firing or sintering with a 300 g muffle is significantly different than with a 100 g muffle.

In this respect, the use of an expensive thermocouple or the temperature detection has the disadvantage that despite the high intrinsic measuring accuracy, the temperature at the relevant point, I.e. at the object to be heated, fired or sintered, cannot be detected exactly.

Furthermore, it has already been proposed in itself to carry out the temperature measurement via the resistance value of the metallic heating wire. Typically, the resistance of a heating wire increases with temperature.

In a dental oven, at least one wall section of the combustion chamber can be opened in order to introduce the combustible material into the combustion chamber. The system is normally designed for operation with the combustion chamber closed. However, there are process steps that take place when the wall section is open (e.g. pre-drying in wet restorations, cooling down). In these process steps, the information that can be obtained by the thermocouple is limited.

Due to the associated temperature ranges, such a resistance temperature measurement was not considered in dental ovens, however, when modeling wax in dental technology, it is much less important in the heating of wax on the accuracy of the temperature.

In this respect, reference is made to DE 31 31 217 A1.

Instead, one has also worked with pyrometers in dental ovens, which are also quite expensive and with which the temperatures of the fuel should be detected from a distance.

In some cases even several pyrometers per dental oven have been proposed, with corresponding cost disadvantages.

DE 10 2016 206 447 A1 also describes a dental oven which monitors the direct current of the induction oven in the power supply unit there and uses it for power calculation. Reliable temperature monitoring is not possible in this way. Instead, a special calibration procedure is used with an additionally provided calibration body with at least 2 measuring materials. The phase transition temperature thereof is recorded, and deviations are used as correction values. This solution is accordingly very complex, and requires careful handling, which includes identification of the possibly several calibration bodies, their positioning in the heating chamber, and the correct inputs into the control device. Direct oven control is not possible since the calibration bodies are removed for the firing program.

In contrast, the invention is based on the object to provide a dental furnace or oven according to the preamble of claim 1, which is improved in terms of the abatement of the temperature profile, which should also result cost advantages or at least no cost disadvantage.

This object is achieved by claim 1. Advantageous developments emerge from the subclaims.

While a temperature detection via a parameter of the heating element, in particular its resistance, is known per se, it is inventively provided that a compensation device is incorporated in the heating control. The temperature control is provided in a dental oven.

The compensation device primarily takes into account non-linearities of the physical parameters of the heating element as a temperature detection device, these nonlinearities relating to the increase in resistance as the temperature increases. These are typically not proportional to each other, but non-linear. Any deviation from proportionality between temperature and resistance of the heating element is named a nonlinearity of the heating element.

If necessary, the compensation device also takes into account the peculiarities of the furnace itself, such as the geometric arrangement of heating elements, the dynamics of the firing cycle to be run, the starting temperature or heating of the furnace at the start of the process.

Considering the first derivative, i.e. Delta R/Delta T in this respect, the differential is negative first when using silicon carbide as a heating element and then positive, and it is positive when using molybdenum silicide. When using FeCrAl or FeCrNi compounds, the differential is different, slightly positive.

It is particularly advantageous if nonlinearities are detected and compensated for at temperatures above 400 degrees Celsius. This temperature range is relevant for firing processes in dental technology which also includes preheating.

The compensation device is not limited to this feature. The compensation device should also advantageously take into account the dead time during the heating of the combustible, i.e the dental restoration parts, based on at least one furnace parameter.

In order to achieve this, a calibration is preferably first carried out, and the determined values are stored in the compensation device of the temperature detection device.

The heating control controls the dental furnace based both on the detected parameter of the heating element, e.g. based on the resistance, and based on the compensation device. “Based” is not to be understood here as exclusive; rather, other measured variables can also be fed to the heating control, and these are then also used for the control and regulation of the dental furnace.

These measured variables can include the output signal of a temperature sensor, e.g. a thermocouple.

According to the invention and surprisingly, a sufficiently accurate but inexpensive temperature control can be realized with this measure since it is not or not absolutely necessary to use an expensive thermocouple or even a pyrometer for the dental oven according to the invention.

On the contrary, it is also possible to use an inexpensive thermocouple that is free of precious metals. This can be installed outside the—hot—firing chamber, which is also referred to here as the heating chamber, e.g. in the thermal insulation.

If required, a thermocouple and/or a pyrometer can be additionally used as a sensor for the oven temperature. Control can then be based on both the output signals from the pyrometer and/or thermocouple and the resistance of the heating element or change thereof.

It is possible to mount pyrometer and/or thermocouple removably in the dental furnace. These can be used for calibration, or as additional temperature sensors if redundancy is desired to increase control reliability.

It is then possible to mount an inexpensive thermocouple (type N or type K) in the thermal insulation or on the outer skin or on the connections for additional information to further increase process reliability, or accuracy or robustness. The cost of such a thermocouple is about half of that of prior art furnace thermocouples.

The combination of compensated heating element resistance sensing according to the invention with a low-cost thermocouple makes it possible to prevent control overshoots.

According to the invention, it is also possible to prevent heating element overload.

Heating elements have a maximum temperature or maximum surface loads at various temperatures which must not be exceeded.

By monitoring the electrical characteristics of the heating elements and the power output, it is possible to ensure that these maxima are not exceeded. This is especially important for dental furnaces with a fast heating rate.

Preferably, in a dental furnace according to the invention, it is provided that the heating element is part of a heating device which heats the heating chamber.

The temperature control according to the invention is particularly advantageous in the situation when thermocouple and heating element are not together when opening the wall portion. This situation can occur during the pre-drying phase and/or during cooling.

According to the invention, it is particularly favorable to use materials with non-linearities and with temperature ranges in which the least non-linearities occur are located very close to the temperature range of the operation of the oven In this range of use, the deviation from proportionality is quite small, e.g. less than 5%. Nevertheless, according to the invention, the accuracy of the temperature detection is increased again by means of the compensation device.

In an advantageous embodiment of the dental furnace according to the invention is namely designed as a predrying oven and thus operates in the range between 80° and 1000° C., preferably between 700° C. and 800° C.

This range is a range in which the nonlinearity is about 3% per 50° C., so is not significantly different from the accumulated measurement errors.

In addition, the non-linearity is positive, so the resistance increases by about 3% more than would be expected with a linear relationship between resistance increase and temperature increase.

In view of this comparatively simple starting situation, it is also possible to realize the compensation device via a so-called look-up table, that is to say in digital form.

The type of realization depends strongly on the temperature range to be covered; If the dental oven according to the invention is implemented as a high-temperature kiln, in any case, a lookup table is recommended as the basis for the compensation device. Alternatively, a correction function or a model can be created as a basis for the compensation device by measuring the furnace.

In any case, it is provided according to the invention that the heating control on the one hand and based on the compensation device on the other hand controls the dental oven based on the resistance of the heating element and thus forms a control loop.

At best, a thermocouple may also be involved in the control loop.

The compensation device can also the temperature distribution along the longitudinal extent of the heating element or the like. include.

If required, the heating control loop described here can be designed separately and, in addition, a control circuit—preferably an internal one—can be realized for a current-voltage control. This control loop can be realized for example as a control in the form of a low-cost integrated circuit, which is then connected to the input of a power semiconductor.

According to the invention, there is provided a method of operating a dental furnace having at least one electrical heating element extending adjacent a heating chamber and controlled by a heating controller. The heating control system controls the temperature in the heating chamber and includes a temperature sensing device. The temperature sensing device senses the resistance of at least a part of at least one heating element and comprises a compensation device, In the compensation device, deviations from the proportionality of the resistance increase of the heating element with the temperature increase of the heating element, i.e. non-linearities, are stored.

According to the invention, the heating controller controls the temperature of the dental furnace based on the detected resistance of at least a portion of at least one heating element and based on the compensation device (50) controls. In the case of a plurality of heating elements, the detection is performed alternately, and the respective heating element measured is briefly de-energized (heating) for this purpose. A measuring current is impressed, and the voltage drop is measured, or a measuring voltage is applied, and the current flowing through the heating element is measured.

In either case, the measured result is fed to the temperature sensing device. The compensation device generates a value from the bare measurement result that corresponds to the actual temperature of the heating element without heating current—and thus essentially the interior of the furnace. This value is used for the heating control.

In the case of a dental oven according to the invention, it is preferably provided that the temperature detection device continuously stores the measured resistance values of the heating element and thus indirectly the temperature values in the heating chamber and thus continuously records a temperature profile of the current firing process over time.

It is preferably provided in a dental oven according to the invention that the heating control continuously monitors the temperature profile, corresponding to the integral over the temperature profile, and incorporates it into the control of the currently set boiler room temperature for adaptation to the desired heat quantity to be introduced into the dental restoration parts.

In an advantageous embodiment of the invention, it is provided that, in order to determine the resistance or corresponding physical parameters, the temperature sensing device passes a current, in particular a direct current, through the heating element and measures the voltage drop across it.

In an advantageous embodiment of the invention, it is provided that, in order to determine the resistance or corresponding physical parameters, the temperature sensing device applies a voltage, in particular a DC voltage, to the heating element and measures the current flowing through it.

In an advantageous embodiment of the invention, it is provided that the heating control system includes the temperature detection device in a control loop that controls the temperature in the heating chamber based on a measured resistance value corresponding to a temperature value.

Preferably, in a dental furnace according to the invention, it is provided that the heating control continuously monitors the temperature profile corresponding to the integral over the temperature curve. Preferably, the temperature profile serves as a manipulated variable in the control loop of the heating control. The heating chamber temperature is set on the basis of this control loop for adaptation to the desired heat quantity to be introduced into dental restoration parts.

The inventively preferred materials may be referred to as metal-ceramic heating elements. These heating elements have a comparatively low resistance, in particular when using molybdenum silicic acid.

For example, while the internal resistance of a Kanthal wire heating element may be 50 ohms, it may be 0.02 ohms for a MoSi heating element, so that there is a difference in internal resistance of three orders of magnitude. This is taken into account by appropriate choice of the input voltage or the input current, or, for example, by a series connection or a parallel connection is realized in MoSi heating elements.

In the case of a dental oven according to the invention, it is preferably provided that the temperature sensing device outputs as measuring voltage an alternating voltage with a special alternating voltage profile that differs from a sine wave and its shape and/or frequency for filtering interference pulses and interference frequencies is discriminatory.

In the case of a dental oven according to the invention, it is preferably provided that the temperature detection device has measuring connections which are in operation in the hot region of the heating element and which are traversed by heating current.

The heating element referred to herein according to the invention is the one used for temperature detection.

The simplest, cheapest and most advantageous case is when heating current=measuring current. Thus, an additional measuring connection is obsolete.

In a further embodiment, the heating element has a measuring connection which lies in the region of the heating element which becomes hot during operation. It can also be realized two corresponding measuring ports spaced from each other. This solution has the advantage that always only the relevant hot area of the heating element is included in the measurement.

This solution is preferred in preheat furnaces with the correspondingly lower temperatures, while in high-temperature furnaces the measuring connections are provided in the cold region of the heating element due to the otherwise existing problems and the cold section of the heating element is then taken into account in the compensation device.

According to the invention it is advantageous if the heating device has a plurality of heating elements, one of which is used as a measuring heating element for heating and for the temperature detection and the other purely for the delivery of heating energy. This simplifies and reduces the circuitry complexity for the temperature detection according to the invention.

Although the measure of the resistance has been found to be an inventive measure, it should be understood that any other electrical parameters of the heating element may be included in the measurement; These parameters are also subsumed under the term “resistance”. In particular, the resistance not only includes the ohmic resistance, but also includes impedance such as inductive and/or capacitive resistors, but also other physical electrical parameters.

The resistance does not have to be measured explicitly. It is also possible to use other inputs, e.g. power controller data (efficiency or similar). This input must correlate with the resistance of the heating elements.

Since voltage and current are available as input variables, both the heating element resistance, which correlates with the heating element temperature, and the heat output can be calculated.

The measurement of the heating element resistance is particularly advantageous when there is no active heating.

If no or only a very low power is emitted by the heating elements, then the temperature in the combustion chamber homogenizes, i.e. the heating element temperature corresponds in the optimum case to the temperature at any other location in the combustion chamber.

If a small “measuring current” is applied to the heating elements in this state, which causes only a very small heating power but allows the resistance to be measured, this allows the temperature in the combustion chamber to be estimated directly.

Deliberate “heating pauses” can also be introduced to eliminate the effect of overheating the heating elements.

In a further advantageous embodiment, a periodic shutdown of heating elements is provided.

If several heating elements are installed in a furnace and these can be controlled individually, the heating current for a single heating element can also be switched off for a short time in the heating process and this element can only be supplied with a “measuring power” in order to determine its resistance in the passive state. Afterwards, the next heating element can be switched off and set to “measure”, and so on.

In this way, not only can any “overheating” of the heating element occurring due to the active heating of the heating element be eliminated during the measurement, but information about the homogeneity of the heating in the combustion chamber can also be obtained.

The dental furnace according to the invention and the associated method can be used particularly advantageously in special phases of the overall process, especially during predrying.

As soon as a wall section of the combustion chamber, i.e. the heating chamber, is opened, the heating behavior or the distribution and course of the energy input changes considerably.

In the state of the art, depending on the position of the temperature sensor and the design of the kiln, the measured value of the temperature sensor can no longer be used in a meaningful way to control the temperature or the course of the energy input into the object. This is particularly the case with predrying in a furnace with a movable thermocouple and/or with a movable firing chamber floor.

In this respect, reference is made to the dental furnace described in EP 3 338 767 A1; this pub-lication is referred to here in its entirety.

Typically, in such a case, less precise process control is required than in the sintering or crystallization process.

In this case, process control can be performed solely by measuring the electrical properties of the heating elements. In this case, a specific heating element resistance can be controlled as a setpoint, rather than a temperature. This makes the process reproducible even without a temperature sensor.

Other applications of process control are also possible via the electrical properties of the heating elements.

These include the control of the start-up firing or regeneration firing.

MoSi heating elements require a running-in firing before use in the dental furnace, which serves to build up the SiO2 protective layer on the heating elements homogeneously. If this run-in firing is controlled according to the state of the art via the installed temperature sensor, the actual temperature of the heating elements is always unknown, since it is always greater than the temperature measured by the sensor.

To circumvent this, sensors could be installed in the immediate vicinity of the heating elements. This would be an additional expense.

With the solution according to the invention, the run-in fire can be controlled via the electrical properties of the heating elements, i.e. it is controlled to a time-resistance profile.

Provided that all heating elements are the same, a profile exactly defined for the heating elements can thus be run off, (almost) independently of the furnace (type) used. The same applies to the regeneration firing.

In addition to the positive effect that the control of these firings becomes more accurate, the de-velopment effort can also be reduced, since the already existing running-in and regeneration firing can be adopted 1:1 when developing a new furnace.

Another possibility according to the invention is the inspection of the heating chamber, in particular the heating elements and the connection technology.

By measuring the electrical properties of the heating elements, the condition of the heating elements or the connection technology can be automatically checked.

The connection technology is also in the measuring circuit, so that malfunctions are detected.

If the heater resistance is recorded during different runs of the same heating profile, the following can be considered: If a change in the resistance profile occurs, the need for maintenance can be determined:

In MoSi heating elements, the resistances of the heating elements remain constant.

This means that if the resistance profile changes, it can be concluded that the connection technology is defective or aging.

For SiC heating elements, the resistance of the heating elements changes due to aging.

Accordingly, for both types of heating elements, a necessary service can be foreseen, or possible adjustments in the control profile can be made, in order to guarantee constant heating pro-files.

The resistance of the connections of the heating elements increases with the service life or also due to transport processes. These terminal resistances are included in the resistance measurement—provided that the entire heating element is included. As a result, the control/measurement of the temperature due to the heating element resistance becomes incorrect over time.

In a particular embodiment of the invention according to claim 15, an offset is provided to compensate—in particular for each current—contact resistance of the terminals.

This compensation may be implemented as part of the compensation device according to the invention.

The resistance offset is determined by running a special program and comparing the measured heating element resistance values with the heating element resistance values measured in the new device in the same program.

This adds a function to the compensation device, namely aging compensation.

By compensating for aging, the accuracy of the control/measurement of the temperature due to the heating element resistance can be significantly increased over the lifetime.

Alternatively, the curve can be compensated in the X-axis direction, i.e., a temperature offset can be introduced instead of a resistance offset.

Furthermore, the possibility of checking the condition of the combustion chamber is particularly favorable.

By means of a short measuring pulse and a recording of the resistance of the heating elements, the thermal condition of the combustion chamber or the immediate vicinity of the heating elements can be checked at any time and in any position. This is particularly important for a furnace with a movable thermocouple and/or with a movable combustion chamber bottom.

If the thermocouple is changed in its position or completely removed from the heating chamber, measurement is no longer possible.

If the combustion chamber bottom is moved upward through the heating chamber to a presenter position according to EP 3 338 767 A1, no information about the temperature in the combustion chamber is available there in the open state. The thermocouple extending through the lid is moved up with it and is then clearly above the combustion chamber.

By checking the resistance of the heating elements, it can then be decided whether the condi-tions for starting a new program have already been met.

In a further advantageous embodiment according to claims 13 and 14, a method is provided in which a limit value for the temperature of the dental furnace at which a firing program can be started is defined in advance. The current temperature of the heating element according to the temperature detection device is compared with the limit temperature by the heating control unit and the firing program is started when the limit value is reached.

Monitoring the firing chamber temperature even when there is no firing program is important.

The temperature reached and thus the firing result of a kiln depends on how heated the furnace is when a firing program is started. For this reason, a limit value is preferably set for the temperature of the furnace at which a firing program can be started. Depending on the opening mech-anism of the furnace, the thermocouple cannot measure the temperature in the furnace when the furnace is open (when the furnace is loaded and the customer then presses START) because it is outside the heating chamber.

To solve the problem, the resistance of the heating elements is used to estimate how hot the heating chamber still is. A restart temperature is set below which a firing program can be started. Short current pulses (of e.g. 15A) are sent through the heating elements at regular intervals, and the on-time should be less than 10%.

As a result, the average power during monitoring is <5 W and hardly affects the cooling of the furnace. These current pulses are used to measure the resistance of the heating elements and thus estimate the current heating element temperature.

In addition, the fans are also controlled based on the heating element temperatures determined by resistance measurement, i.e. if the temperature falls below a value, the fans are switched off.

Here is an example of temperature measurement by heating element resistance:

After completion of the active firing process, a current pulse of 3 s is impressed every 1 min to measure the resistance of the heating elements and thus the temperature in the chamber. While the furnace has not yet fallen below a defined threshold temperature, the fans are set for cooling and no new program can be started.

Further advantages, details and features will become apparent from the following description of an embodiment of the invention with reference to the drawing.

The following items are shown:

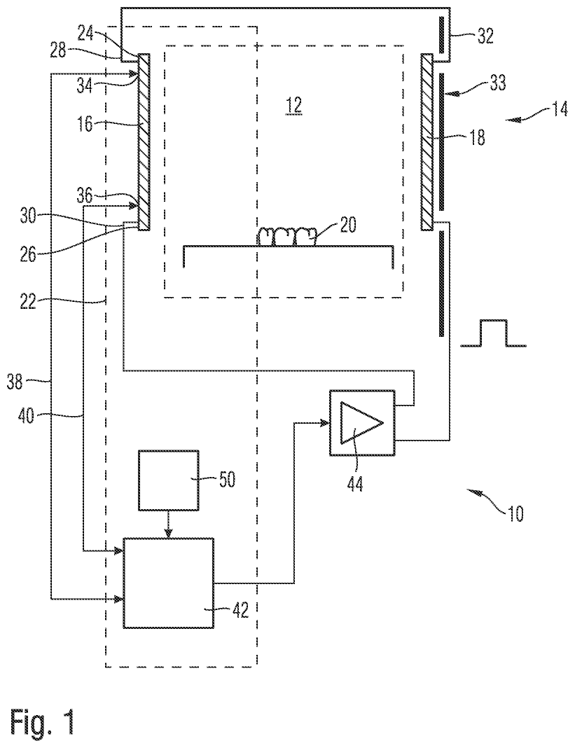

FIG. 1 shows a schematic representation of a dental oven according to the invention, showing the components essential to the invention;

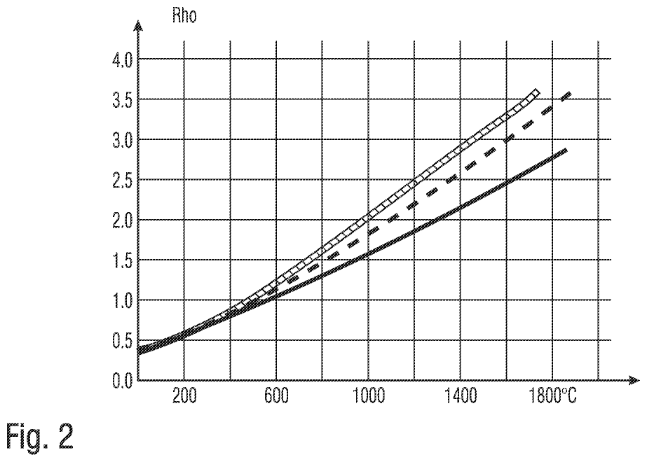

FIG. 2 shows the resistance/temperature characteristic of a MoSi heating element of a dental oven according to the invention in one embodiment;

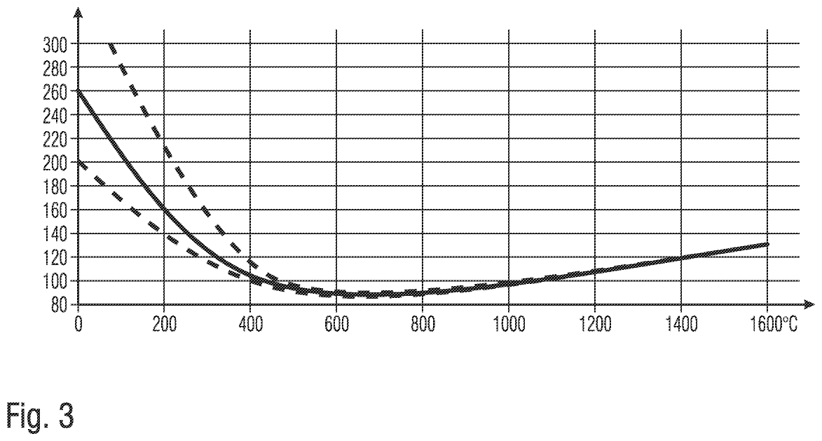

FIG. 3 shows another resistance/temperature characteristic in standardized form.

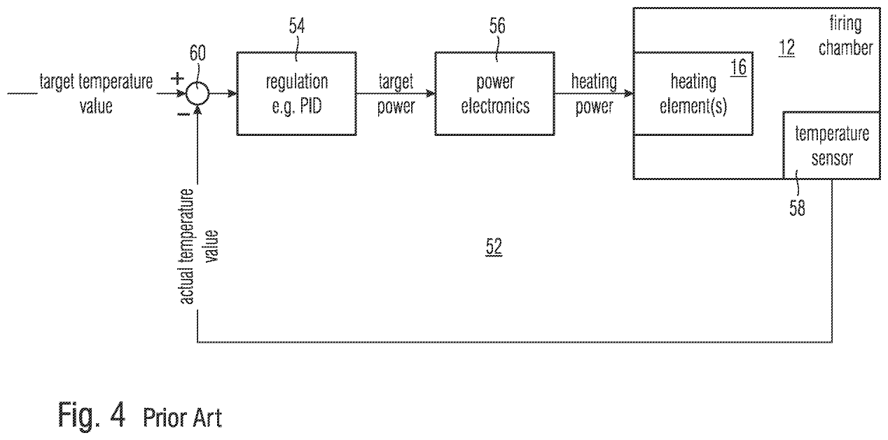

FIG. 4 shows a typical control loop of a temperature control of a dental furnace according to the prior art;

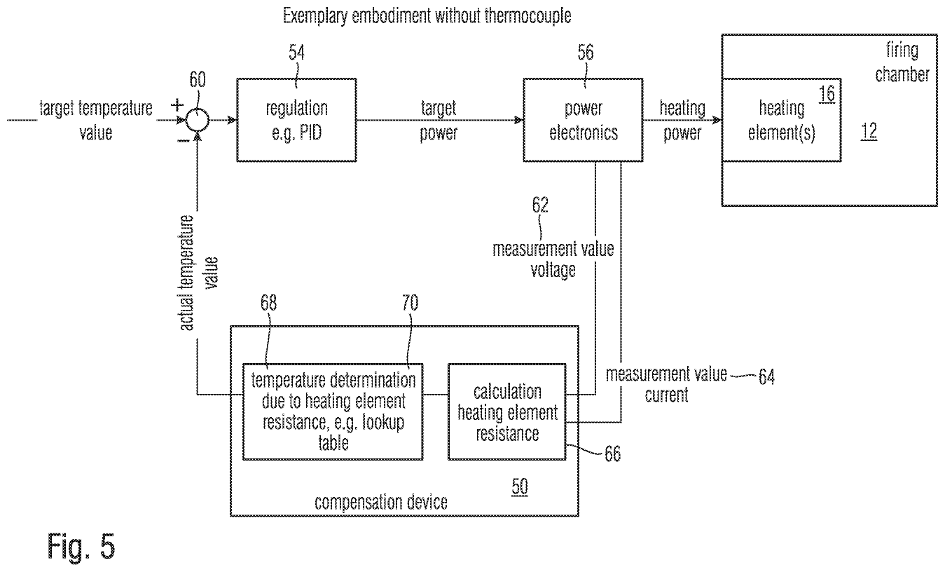

FIG. 5 shows an embodiment of the invention showing a control loop according to the invention, wherein no thermocouple is used in this embodiment;

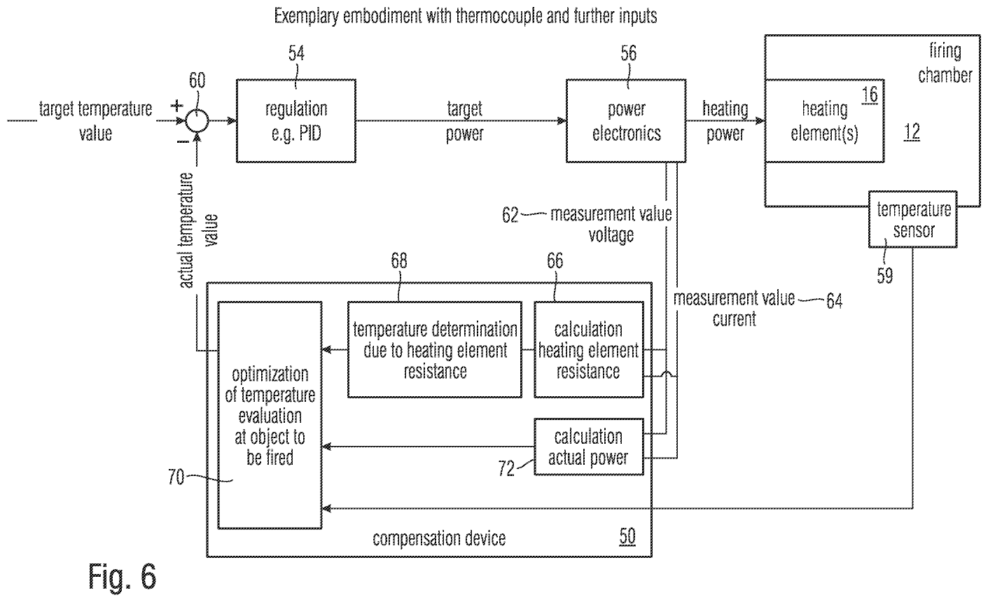

FIG. 6 shows an embodiment of the invention showing a control loop according to the invention, wherein a thermocouple is used in this embodiment;

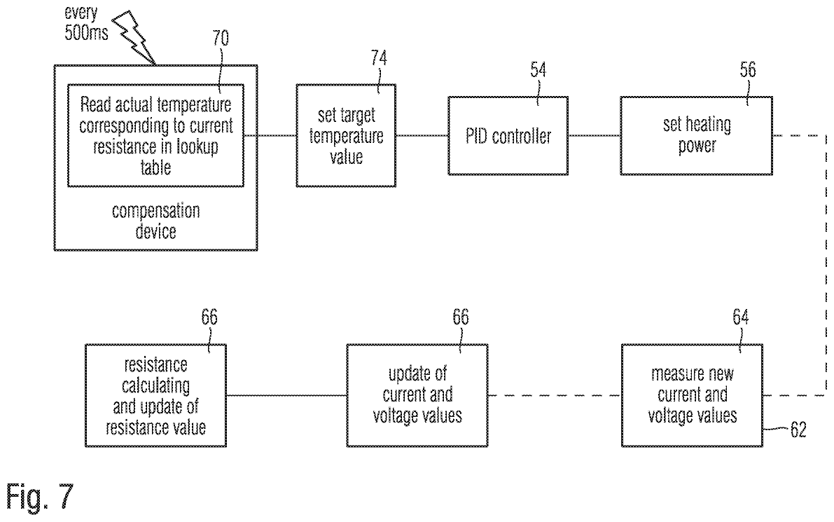

FIG. 7 shows a control diagram as part of the control loop, illustrating the interaction of the compensation device in temperature sensing;

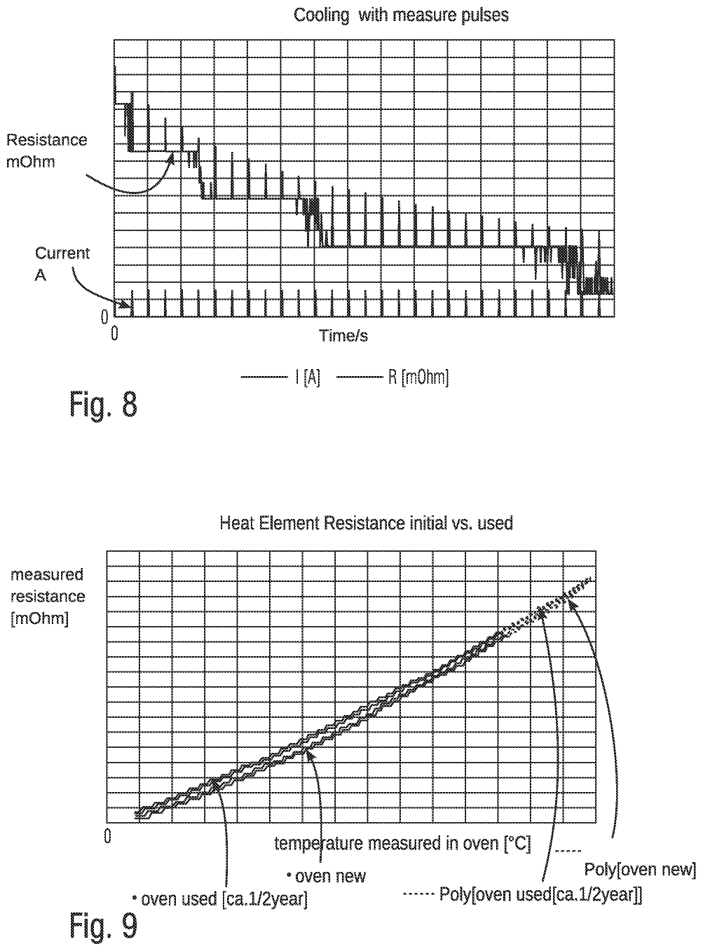

FIG. 8 shows a diagram showing impressed measuring current pulses and the resistance value measured for each as cooling progresses;

FIG. 9 shows a graph showing the measured heating element resistance, one in new condition and the other in used condition; and

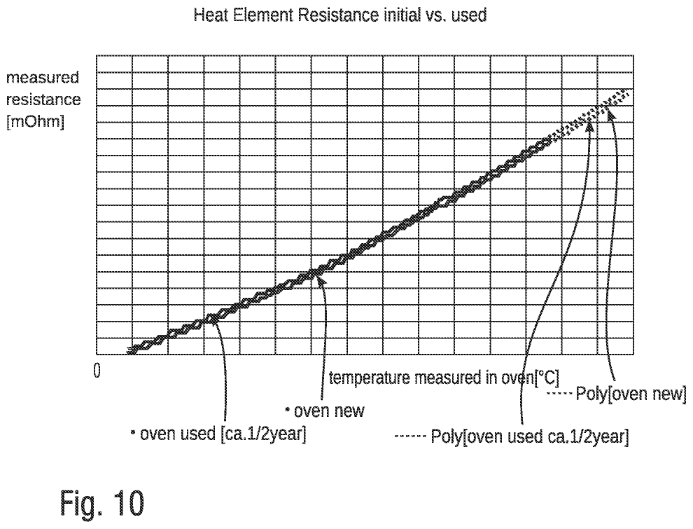

FIG. 10 shows the two curves shown in FIG. 8 after compensation by offsets.

From FIG. 1, a dental oven 10 is schematically apparent in its relevant to the invention parts.

This includes a heating chamber 12, which is heated by a heater 14. The heating device 14 consists of several heating elements, of which from FIG. 1, the heating elements 16 and 18 are visible. The heating elements extend annularly around the heating chamber 12.

The heating chamber 12 is intended for receiving dental restoration parts 20, which are shown schematically in FIG. Although here the dental oven 10 is formed as a kiln, it is understood that instead of a press furnace with a muffle may be formed according to the invention, or a sintering furnace, a crystallization furnace, a preheating furnace, a predrying, a debinding furnace or a heat curing polymerization furnace/device.

The illustrated dental oven 10 is multifunctional, so it can be used both as a preheating oven with temperatures around 800°, but also as a high-temperature sintering oven with temperatures around 1800°. Accordingly, the heating elements are temperature resistant. In the illustrated embodiment, they consist of SiC.

In the illustrated embodiment, the heating element 16 is part of a temperature sensing device 22. It has heating power connections 24 and 26 attached to the heating element 16 at two spaced apart locations. The heating element is traversed by the heating current, which also flows through further heating elements such as the heating element 18.

In the illustrated embodiment, the heating current line passes through a respective passage 28 and 30, at which the heating current line 32 passes through a heat insulation, not shown, of the furnace.

The heating current causes a voltage drop across the heating element, and the heating element heats up and thus also heats the heating space 12.

In the illustrated embodiment, in addition to the heating current terminals 24 and 26 on the heating element 16, a measuring current connection 34 near the heating current terminal 24 and a measuring current connection 36 near the heating current terminal 26 attached to the heating element. The respective measuring lines 38 and 40 can be passed through the passages 28 and 30 with it.

This embodiment has the advantage that the changing internal resistance of the heating element 16 only completely affects the measuring current in the region of the heating chamber 12.

The temperature detection device 22 has a control device 42. The control device 42 has an output terminal which is connected to the heating controller 44 and controls and regulates the heating current in the heating power line 32.

The controller 42 also provides the measurement current in the sense lines 38 and 40. The voltage drop across the heating element is measured. Preferably, the heating element 16 as a measuring resistor in a known per se resistance measuring bridge integrated.

It is also possible to combine the heating-current connection 24 and the measuring-current connection 34, and correspondingly the heating-current connection 26 and the measuring-current connection 36, each in one connection. However, a part of the heating current flowing through the area of the heating current line is then cold and thus contributes nothing to the measurement result.

The measuring lines 38 and 40 are preferably of low resistance, and the measuring current terminals 34 and 36 have a very low contact resistance to the heating element 16.

The measuring current in the measuring circuit is chosen so that it does not or not measurably affect the current temperature of the heating element, i.e. the heating element is not further heated. For example, the measuring current can be 5 mA, and the measuring voltage 20 mV, corresponding to an internal resistance of existing SiC heating element 16 of 4 ohms.

The heating element 16 is part of the temperature sensing device 22 and serves as a measuring resistor. It basically forms the temperature during heating, namely the temperature of the heating element 16.

The temperature of the dental restoration part 20 is typically significantly lower than that of the heating element 16, at least during the temperature change.

In addition, the internal resistance of the heating element 16 increases with increasing temperature, but not exactly proportional, but non-linear.

The control of the heating control is now carried out so that in principle the measured resistance of the heating element 16 is used as the basis for the control. In addition, however, the output signal of a compensation device 50 is taken into account, which is also part of the temperature detection device 22.

The compensation device 50 compensates for the non-linearity of the heating element 16. The non-linearity is material-dependent and known per se. If necessary, a measurement curve of the currently used heating element can be run through and stored for the calibration, so that the non-linearities are stored furnace-specific in the compensation device and the control device 22 can determine the exact temperature of the heating element 16.

Furthermore, it is also possible to mathematically take into account the temperature gradient during the heating, likewise in the temperature detection device 22, in particular in the compensation device 50. A large temperature gradient such as 50° C. per minute or even 80° C. per minute leads to a large temperature difference between the dental restoration part 20 and the heating element 16.

If the heating element 16 is kept at a constant temperature, based on the control by the temperature sensing device 22, this does not mean following a period of rapid heating that the temperature difference, i.e the local temperature gradient in the heating chamber 12 falls to zero; this occurs only gradually, based on heat transfer via convection and heat radiation.

These two deviations between the temperature of the heating element 16 and that of the dental restoration part 20 can be considered empirically and/or mathematically and can also be incorporated into the control.

The measures taken in this respect can be made, for example, according to EP 1 915 972 B1, to which reference is made in its entirety here.

In the embodiment shown here, it is provided to conduct the heating current through the heating current line 32 in pulse form. In pulse intervals, the heating element 16 is flowed through by measuring current. The pulse break can be e.g. 10 ms long.

In relation to the pulse pause length of the temporal temperature gradient is low. A long pulse break can be used to record the behavior during the break and thereby draw conclusions about the heating of the furnace. A slow cooling during the break means that the stove is very warm.

For example, the measurement can take place every third pulse break, and as a precaution, not immediately at the beginning of the pulse break, but, for example, at 10% of the length of the pulse break, the measurement time can then be completed, for example, 20% of the pulse break. This excludes the possibility that the heating element 16 cools by more than a few tens to a hundred milligrams, and thus the measurement result is falsified.

At 10% of the pulse break, any physical effects produced by the high heating current, such as, in particular, lattice vibrations, self-induction and so on, should decay, so that these too cannot influence the measuring current.

According to the invention, it is particularly advantageously provided that the form of temperature control shown here is used during the process step of pre-drying. In this process step, a wall section is opened, making it difficult to control via a thermocouple, depending on the design of the furnace even impossible.

According to the invention, a good temperature control with the features of claim 1 is still possible with an open wall section, and with satisfactory accuracy, and even over the entire operating area.

It is also possible to use the dental oven according to the invention exclusively or additionally as a kiln, for example at temperatures up to 1800° C. Again, the temperature detection device of the invention is used to control the temperature.

Furthermore, it is also possible to use a thermocouple or another temperature sensing element in addition to the temperature detection shown here via the temperature sensing device 22. Here it is possible that the two ways of temperature sensing each other control or supplement.

In FIG. 2 is plotted how the resistivity, plotted against the temperature, nonlinearly developed. The specific resistance Rho of the material measured here, namely molybdenum silicide, initially decreases less strong and then stronger, depending on the material used.

In an exemplary experiment, temperature measured values of 100° C. to 1550° C. were determined and normalized resistance values were determined. At 650° C., the normalized resistance value is 1.11, which is almost half as high as at 100° C. The normalized resistance increases only slightly, i.e. by 6%, up to 850° C., so that here an area of relatively low nonlinearity or better linearity is present.

At 1550° C., however, the normalized resistance value has then risen to 1.47, so that the compensation device 50 according to the invention the nonlinearity must compensate.

In FIG. 3, a normalized resistance is plotted here for silicon carbide. Again, it can be seen that the near-linear region of the non-linearity curve is less than 1100° C., approximately in the region around 700° C.

The family of curves apparent in the lower temperature range corresponds to different forms of the silicon carbide compound, and depends, for example, on its purity.

At somewhat higher temperatures, molybdenum disilicide forms a passivating layer of silicon dioxide which is produced, for example, via a burn-in fire and then protects the silicon carbide and makes it durable. Ideally, this break-in fire is controlled directly via the properties of the heating elements, since in this break-in fire, the time sequence of the temperature of the heating elements is relevant to the quality of the SiO₂ layer.

In an advantageous embodiment, after the run-in firing and the calibration of the oven determines a difference curve for the measured temperature in relation to the heating power introduced and stored, for example in the compensation device 50.

For example, a test firing is performed automatically or manually after, for example, 50 firing cy-cles. If the ratio between the applied power and the measured temperature differs by more than a predetermined value, for example 5% or 10%, from the reference curve, a recalibration is re-quested; if this is no longer possible, it means that the life of the heating element 16 and thus the other heating elements is reached.

FIG. 4 shows a control circuit for a well-known and widely used dental furnace. In a manner known per se, the temperature is set as the setpoint. The control circuit 52 includes a PID controller 54, which provides the oven power at its output port. The output terminal of the PID controller 54 is connected to the input terminal of the power electronics 56, which in turn ensures that the heating element 16 or the heating elements are supplied with heating power.

The heating element 16 is located in a combustion chamber, which is also referred to as the heating chamber 12.

A temperature sensor 58 is disposed in the combustion chamber 12 or on the thermal insulation surrounding the combustion chamber 12, which ultimately measures the temperature at that location of the heating chamber 12 and is actually intended to sense the temperature of the dental restorations 20.

Typically, there is a significant distance between the dental restoration 20 and the temperature sensor 58, and therefore, due to the local temperature gradient in the heating chamber 12, the temperature sensor 58 is unable to accurately sense the temperature of the dental restoration 20, if at all.

The output signal from the temperature sensor 58 is fed to a comparator 60 which dictates the control, i.e., increases the temperature when the temperature set point is greater than the actual temperature value and ultimately reduces the heating power when the temperature set point is less than the actual temperature value.

A control loop 52 is also provided in the embodiment according to the invention with the block diagram shown in FIG. 5. There, a PID controller 54 is also used, and the power electronics 56 and the heating element 16 in the heating chamber 12.

However, measuring bridges are arranged on the output side of the power electronics 56, which are to detect the output voltage and the output current. A measured value “voltage” 62 and a measured value “current” 64 are detected and processed.

The measured values in question can also be tapped in the area of the lines between the power electronics 56 and the heating element 16, or adjacent to the heating element 16.

According to the invention, the measured values “voltage” 62 and “current” 64 are supplied to the compensation device 50. The compensation device 50 comprises a calculator 66 for calcu-lating the heater element resistance, based on the measured values for voltage 62 and current 64.

Further, the compensation device comprises a temperature determination device 68, which may be, for example, a lookup table 70.

The heating element resistance calculated in the computer 66 is supplied to the temperature determination device 68, so that on the output side the lookup table 70 or the temperature determination device 68 is provided with the actual temperature as an actual temperature value.

This detected actual temperature value is fed to the comparator 60 as in FIG. 4, and the control in this respect is carried out in the usual manner.

A further embodiment of a block diagram according to the invention is shown in FIG. 6. This is supplemented by the temperature sensor from the prior art and in this respect combines the invention with it.

As in the block diagram according to FIG. 4, a temperature sensor 59 is associated with the heating chamber 12. However, as can be seen from FIG. 6, it is arranged only partly in the heating chamber 12 and partly outside. In fact, a temperature sensor 59 can be used here that is less temperature resistant and is placed, for example, in the middle of the thermal insulation of the dental furnace. Such a temperature sensor 59 may cost, for example, ⅓ of what the temperature sensor 58 of FIG. 4 costs.

As in the block diagram of FIG. 5, the combination device 50 has a computer 66 and a temperature determination device 68. These have the same functions.

However, the output terminal of the temperature determination device 68 is not connected to the comparator 60, but is connected to an optimization device 70. The optimization device 70 is used to optimize the temperature estimation on the firing object.

The output of the temperature sensor 59 is connected to the optimization device 70.

In the illustrated embodiment, the optimization device 70 has another input port connected to a computer 72. The computer 72 calculates the actual power from the combination of the measured value “voltage” 62 and the measured value “current” 64, and feeds the calculated actual power to the optimization device 70.

The optimization device 70 outputs an actual temperature value which is fed to the comparator 60.

The setpoint/actual control according to the control loop 52 is cyclic in both the embodiment according to FIG. 5 and that according to FIG. 6. The control loop 52 can be cycled at constant time intervals, although it is also possible to shorten the time intervals when the temperature changes rapidly and to lengthen the time intervals when the temperature is more or less constant.

For example, measurement and control can be performed every 500 milliseconds.

FIG. 7 shows the control scheme in this respect. Within the compensation device 50, the lookup table 70 is read and thus the current actual temperature is output. The setpoint temperature 72 is set and the control difference between setpoint temperature and actual temperature is fed to the PID controller 54. The heating power is set by the power electronics 56. New current values 64 and voltage values 62 are measured based on the current output power of the power electronics 56 and the heater 16. The measured values are evaluated in the computer 66, and the resistance calculation is performed and the resistance value is updated. This is also done in the computer 66.

The determined new resistance value is fed to the lookup table 70, and in another 500 milliseconds the controlled system is run through again.

The lookup table, as an important part of the compensation device 50, is empirically determined in advance and allows a fairly accurate temperature determination An excerpted lookup table 70 is shown below.

Lookup table

| Resistance 4 | Temperature |
|---|---|
| heating | heating |
| elements in | elements in |
| micro-ohm | degrees C. |
| 26500 | 100.6 |
| 26600 | 101.8 |
| 26700 | 103.0 |
| 26800 | 104.2 |
| 26900 | 105.3 |
| 27000 | 106.5 |
| 160000 | 1214.6 |
| 160100 | 1215.3 |
| 160200 | 1216.0 |
| 160300 | 1216.7 |
| 160400 | 1217.3 |
| 212700 | 1600.5 |
| 212800 | 1601.3 |
| 212900 | 1602.1 |
| 213000 | 1602.9 |
| 213100 | 1603.7 |
| 213200 | 1604.6 |

FIG. 8 shows an example of temperature measurement during cooling according to the invention. It can be seen that a current pulse is regularly impressed into a heating element without heating current. The associated resistance value is measured.

Thus, after completion of the active firing process, a current pulse is impressed to measure the resistance of the heating elements and thus the temperature in the chamber. While the kiln has not yet fallen below a defined threshold temperature, the fans are set for cooling and no new program can be started.

FIGS. 9 and 10 show the compensation of the increasing resistance of the heating element connections. Due to aging or other effects—e.g. mechanical load, the resistance can increase.

This is compensated by periodically (e.g. every 3 months) measuring the resistance of the heating element and comparing it with that of a new heating element. An offset is calculated from the difference. According to FIG. 9, this offset is temperature-dependent. It is ever stored in the compensation device and thus taken into account when the actual temperature is recorded.

FIG. 10 shows that in this respect, almost complete compensation is also possible for aging effects.

When introducing an offset, which estimates the actual contact resistance of the connection technology, the following function can be used:

T_heating_elements=f(R_measured−R_offset).

The function f can again be stored as a lookup table.

By compensating the increased resistance due to aging (especially the connection technology) by an offset, the curves used and old lie on each other again. Of course, a more complex or complicated compensation than a simple offset can be used, e.g. to compensate for temperature dependent effects etc.

1. A dental oven comprising
at least one electric heating element (16) which extends adjacent to a heating chamber (12) and is controlled by a heating control (44),
wherein the heating control (44) regulates the temperature in the heating chamber (12) and has an output connection for the at least one electric heating element (16) and an input connection for detecting the temperature of the at least one electric heating element (16),
wherein the input connection is electrically connected to a temperature detecting device (22), wherein the temperature detecting device (22) comprises the at least one electric heating element (16),
wherein the temperature detecting device (22) comprises a compensation device (50) configured to compensate for nonlinearities at temperatures above 400° C. detected by the temperature detecting device (22), and
wherein the heating controller (44) controls the output connection based on the detected resistance of the at least one electric heating element (16) or a part of the at least one electric heating element (16) or all heating elements (16,18) and based on the compensation device (50).

2. The dental oven according to claim 1,
wherein the temperature detecting device (22) detects the current temperature of the at least one electric heating element (16) by determining the resistance of the at least one heating electric element (16), which also includes impendences, inductive and/or capacitive resistances, or equivalent parameters.

3. The dental oven according to claim 1, wherein the heating control (44) comprises at least two control circuits comprising an internal control circuit which controls the heat output based on a current/voltage characteristic field, and an external control circuit which incorporates the temperature detecting device (22) which controls the temperature in the heating chamber (12) based on a measured resistance value of the at least one electric heating element (16) corresponding to a temperature value.

4. The dental oven according to claim 1, wherein the heating control (44) delivers pulsed heating power,
wherein the temperature detecting device (22) measures the resistance of the at least one electric heating element (16) and indirectly the temperature in the heating chamber (12) in no-pulse periods or pulse pauses of the heating power, with a pulse length of 10 ms to 20 s and no-pause length of between 2 ms and 10 s.

5. The dental oven according to claim 1, wherein the temperature detecting device (22) measures the resistance of the at least one electric heating element (16) and indirectly the temperature in the heating chamber (12) at the beginning of pulse pauses or no-pulse periods of the heating power in a measuring period which has a length of less than 10 s and has a length of more than 10 ms.

6. The dental oven according to claim 1, wherein the at least one electric heating element (16) is at least partially made of compounds of MoSi, SiC, FeCrAl or FeCrNi, and has a resistance of less than 60 ohms at room temperature.

7. The dental oven according to claim 1, wherein the temperature detecting device (22) emits a measuring current, and measures a voltage drop across the at least one electric heating element (16), or across a part thereof or across all heating elements (16, 18) as a measuring voltage,
wherein a product of measuring current and measuring voltage gives a measuring power of less than 10% of the maximum electric heating power of the dental oven or less than 1% of the maximum electric heating power of the dental oven, or the measuring current corresponds to the heating current and the measuring voltage corresponds to the heating voltage, respectively.

8. The dental oven according to claim 1, wherein the temperature detecting device (22) in the compensation device (50) has a look-up table, in which non-linearities of the at least one electric heating element (16) detected in a calibration step are stored, or the temperature detecting device (22) determines a function that represents the relation of resistance and temperature in the heating chamber (12), and
wherein the calibration step of the temperature detection device (22) covers temperatures between room temperature and 1900 degrees Celsius over an entire temperature range.

9. The dental oven according to claim 1, wherein the temperature detection device (22) in a run-in firing and/or a regeneration firing of all of the heating elements (16,18) of the heater (32) operates without an additional temperature sensor.

10. The dental oven according to claim 1, wherein the temperature detecting device (22) has a test mode in which it detects the resistance value of the at least one electric heating element (16) at a predetermined state of the oven and the temperature detecting device (22) detects, the aging of the at least one electric heating element (16) or the need to recalibrate/service the furnace when a deviation of the measured resistance value from a value determined during calibration by more than a predetermined tolerance occurs.

11. The dental oven according to claim 1, wherein the temperature detecting device (22) indirectly detects the measuring current through the at least one electric heating element (16), and the uncompensated output value for the temperature measurement, indirectly via an output signal of a power supply unit for the at least one electric heating element (16), which output signal reflects a parameter of the power supply unit.

12. A method of operating a dental oven, comprising at least one electrical heating element (16) extending adjacent a heating chamber (12) and controlled by a heating controller (44), the method comprises the following steps:
the heating controller (44) regulates a temperature in the heating chamber (12) and has a temperature detection device (22),
the temperature detection device (22) detects the resistance of at least a part of the at least one electrical heating element (16) and comprises a compensation device (50),
deviations from the proportionality of the resistance increase of the at least one electrical heating element (16) with the temperature increase of the at least one electrical heating element (16) or nonlinearities, are stored in the compensation device (50)
the heating controller (44) controls the temperature of the dental furnace based on the detected resistance of at least a part of at least one electrical heating element (16) and based on the compensation device (50).

13. The method according to claim 12,
wherein a limit value for the temperature of the dental oven at which a firing program is configured to begin is determined in advance, and
wherein the current temperature of the at least one electrical heating element (16) according to the temperature detection device (22) is compared by the heating control (44) with the limit value temperature and the firing program is started when the limit value is reached.

14. The method according to claim 12,
wherein, for the detection of the temperature of the at least one electrical heating element (16), short current pulses comprising pulses with a duty cycle of less than 20 percent are sent through the heating element and during these short current pulses, the temperature detection device (22) measures the resistance of at least a part of the at least one electrical heating element (16).

15. The method according to claim 12,
wherein the resistance of the newly installed at least one electrical heating element (16) is detected and stored, and
wherein the detection of the resistance of the at least one electrical heating element (16) is repeated at time intervals of at least 3 months, and the measured difference is stored as an offset reflecting the aging of the at least one electrical heating element and/or its-connections of the at least one electrical heating element and is also used in the temperature detection.

16. The dental oven according to claim 1 for predrying dental restoration parts,
wherein the nonlinearities at temperatures above 400° C. are nonlinearities of the resistance of the at least one electric heating element (16).

17. The method according to claim 14,
wherein the duty cycle is less than 7 percent.

18. The method according to claim 12,
wherein the detection of the resistance of the heating element (16) is repeated at time intervals of at least one week.

19. The dental oven according to claim 6,
wherein the at least one electric heating element (16) has a resistance of less than 10 ohms at room temperature.
